(19) United States
(12) Patent Application Publication
(10) Pub. No.: US 2022/0326332 A1
(43) Pub. Date: Oct. 13, 2022

(54) SOUND COLLECTING APPARATUS, ARRIVAL DIRECTION ESTIMATING APPARATUS, AND VIBRATION INFORMATION COLLECTING APPARATUS

(71) Applicant: NIPPON TELEGRAPH AND TELEPHONE CORPORATION, Tokyo (JP)

(72) Inventors: Kazunori KOBAYASHI, Tokyo (JP); Hiroaki ITO, Tokyo (JP); Shin MURATA, Tokyo (JP)

(73) Assignee: NIPPON TELEGRAPH AND TELEPHONE CORPORATION, Tokyo (JP)

(21) Appl. No.: 17/615,817

(22) PCT Filed: Jun. 6, 2019
(86) PCT No.: PCT/JP2019/022567

§ 371 Date: Dec. 1, 2021

(51) Int. Cl. G01S 3/808; G01H 3/12; G01S 3/86

(52) U.S. Cl. CPC G01S 3/8083; G01H 3/125; G01S 3/86

(57) ABSTRACT

Sounds arriving from outside of a mobile body are collected by a microphone disposed inside the mobile body. A sound collecting apparatus according to the present disclosure is attached to the mobile body. The sound collecting apparatus according to the present disclosure includes a microphone that is directly or indirectly in contact with an outer face member, which is a member forming an outer face of the mobile body, from an inner side of the mobile body and collects sounds propagating through the outer face member. In a case where the microphone has directivity, the microphone is disposed in a direction in which sounds propagating from the outer face of the outer face member to the inner side are collected. The outer face member is, for example, glass.

### TECHNICAL FIELD

The present disclosure relates to a sound collecting apparatus, a arrival direction estimating apparatus, and a vibration information collecting apparatus for an acoustic signal arriving from the outside of a mobile body.

### BACKGROUND ART

As disclosed in Non Patent Literature 1, techniques for installing a microphone on the inner side of a vehicle and collecting sounds inside the vehicle are known as related technologies.

### CITATION LIST

### Non Patent Literature

Non Patent Literature 1: Nippon Telegraph and Telephone Corporation, “Speech Enhancement Technology for In-car Communication”, [Retrieved on May 22, 2019], Internet <http://www.ntt.co.jp/RD/active/201802/en/pdf_eng/F10_e.pdf>.

### SUMMARY OF THE INVENTION

### Technical Problem

However, a technology for collecting sounds arriving from outside of a vehicle using a microphone disposed inside the vehicle is not known. An objective of the present disclosure is to collect sounds arriving from the outside of a mobile body using a microphone disposed inside the mobile body.

### Means for Solving the Problem

A sound collecting apparatus according to the present disclosure is attached to a mobile body. The sound collecting apparatus according to the present disclosure includes a microphone that is directly or indirectly in contact with an outer face member, which is a member forming an outer face of the mobile body, from an inner side of the mobile body and is configured to collect a sound propagating through the outer face member.

### Effects of the Invention

According to the sound collecting apparatus of the present disclosure, a microphone that is in contact with an outer face member from the inner side is provided, and thus sounds arriving at the outer face of a mobile body can be collected by a microphone disposed inside the mobile body.

### BRIEF DESCRIPTION OF DRAWINGS

FIG. 1 is a diagram illustrating an example of the configuration of a sound collecting apparatus according to the present disclosure.

FIG. 2 is a diagram illustrating a processing flow of a sound collecting apparatus according to the First Embodiment.

FIG. 3 is a diagram illustrating an example of the configuration of a sound collecting apparatus to which a sound insulation structure that blocks sounds of the inside of a mobile body is added.

FIG. 4 is a diagram illustrating an example of the functional configuration of a arrival direction estimating apparatus according to the present disclosure.

FIG. 5 is a diagram illustrating a view in which a plurality of sound collecting apparatus are disposed in one outer face member.

FIG. 6 is a diagram illustrating a view in which sound collecting apparatus are disposed in different outer face members.

FIG. 7 is a diagram illustrating an example of a processing flow of the arrival direction estimating apparatus according to the present disclosure.

FIG. 8 is a diagram illustrating an example of the functional configuration of a computer.

### DESCRIPTION OF EMBODIMENTS

Hereinafter, embodiments of the present disclosure will be described in detail. Components having the same function are denoted by the same reference signs, and redundant description thereof will be omitted.

### The First Embodiment

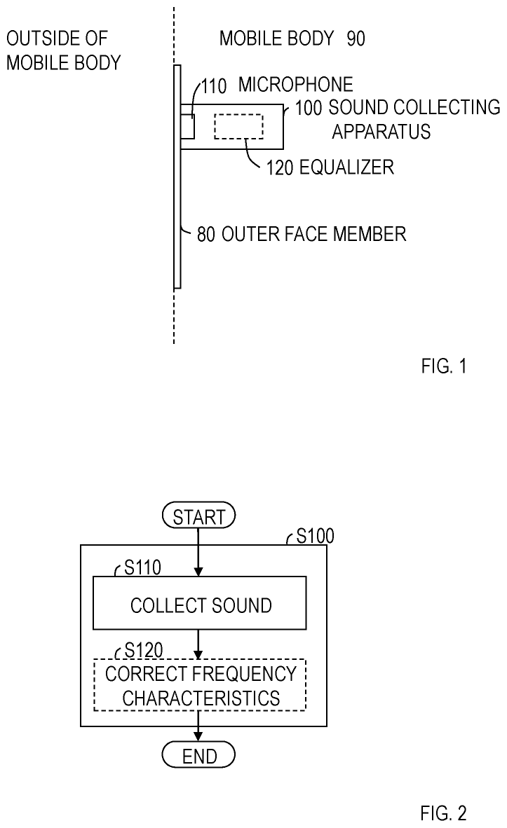

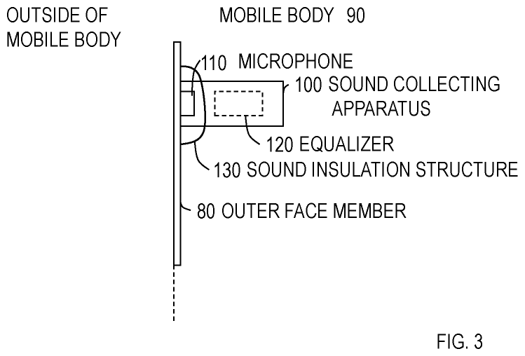

FIG. 1 illustrates an example of the configuration of a sound collecting apparatus according to the First Embodiment, and FIG. 2 illustrates a processing flow of the sound collecting apparatus according to the First Embodiment. FIG. 3 illustrates an example of the configuration of a sound collecting apparatus in which a sound insulation structure that blocks sounds of the inside of a mobile body is added. The sound collecting apparatus 100 is attached to a mobile body 90. The sound collecting apparatus 100 includes a microphone 110 that is directly or indirectly in contact with an outer face member 80, which is a member forming an outer face of the mobile body 90, from the inner side of the mobile body 90. The microphone 110 collects sounds that propagate through the outer face member 80 (S110). The “outer face member 80”, for example, is glass, a metal plate configuring a vehicle body, a carbon fiber, or the like, but is not limited thereto. However, in a case where the outer face member 80 is a member configuring the vehicle body such as the metal plate, the carbon fiber, and the like, it frequently has a layer structure in which a layer of air is present, and thus propagation characteristics of sounds propagating from an outer face of the outer face member to an inner side may easily depend on a position and may easily become complicated. On the other hand, in the case of glass, even when a layer structure is formed like laminated glass, the structure is frequently not hollow, and the propagation characteristics may not easily depend on a position and may not easily become complicated. In addition, a member such as rubber absorbing vibration is frequently disposed between the glass and the vehicle body, and thus a structure in which vibration (sounds) generated by the mobile body itself such as an engine sound and the like does not easily propagate to the glass is formed. Thus, the glass used as the outer face member 80 is appropriate for collecting sounds from the outside. “Directly in contact” means that the microphone 110 is directly in contact with the outer face member 80. “Indirectly in contact” means that a certain member is present between the microphone 110 and the outer face member 80 as in a case where the microphone 110 is in contact with the outer face member 80 through an adhesive agent. As a member other than the adhesive agent that is present therebetween, there may be an object through which a sound can be caused to easily propagate such as a metal. The member present therebetween does not include air.

In addition, as illustrated in FIG. 3, in order not to collect as few sounds of the inside of the mobile body as possible, a sound insulation structure 130 may be disposed on the inner side of the outer face member 80 such that sounds from the inner side of the mobile body 90 do not directly reach the outer face member 80 near the microphone. Furthermore, the sound insulation structure may be a sound insulation structure that does not collect sounds arriving from other than the outside of the mobile body. For example, in a case where a structure that blocks sounds propagating through the outer face member 80 from other than near the microphone is employed, the microphone can easily collect sounds arriving from the outside of the mobile body.

In a case where the microphone has directivity, the microphone is disposed in a direction in which sounds propagating from the outer face of the outer face member 80 to the inner side are collected. In addition, in the present disclosure, a “window glass” is appropriate as the outer face member 80, and thus the effect can be more easily acquired in a case where the “mobile body 90” is a riding object such as a vehicle. However, the present disclosure can also be used in objects in which a person does not ride such as a radio-controlled car, an unmanned airplane, and the like, in other words, objects having no window glass.

The sound collecting apparatus 100 according to the present disclosure includes the microphone 110 that is in contact with the outer face member 80 from the inner side, and thus sounds arriving at the outer face of the mobile body 90 can be collected by the microphone 110 disposed inside the mobile body 90. In addition, the sound collecting apparatus 100 can be disposed on the inside of a mobile body having a good environment, and thus can be less influenced by environmental factors such as weather and the like at the time of collecting sounds.

The First Modification

The sound collecting apparatus 100 may further include an equalizer 120. The equalizer 120 receives an acoustic signal that is output from the microphone 110 as an input. The equalizer 120 corrects the input acoustic signal in accordance with frequency characteristics that are opposite to the frequency characteristics of the outer face member 80 when sounds propagate from the outer face to the inner side (S120). Glass has a frequency (resonant frequency) that easily vibrates, a sound can easily propagate to the microphone at that frequency, and the sensitivity of the resonant frequency becomes high with characteristics of a combination of the glass and the microphone. In addition, there is a feature that a glass face is less likely to vibrate as the frequency becomes higher, and there is a trend that the sensitivity becomes lower as the frequency is higher. In order to correct this, by including an equalizer set such that a gain of a signal having a high frequency is raised, and a gain for the resonant frequency of the glass is lowered, a flat frequency characteristic can be achieved. In this way, by including the equalizer 120, even when sounds of the outside are collected through the outer face member 80, a flat frequency characteristic can be achieved. The frequency characteristics of the outer face member 80 when sounds propagate from the outer surface to the inner side are measured using the actual outer face member 80.

The Second Modification

In the First Embodiment and the First Modification described above, the measuring target has been described as “sounds”. However, a sound is one type of vibration, and thus, the measuring target may be “vibration”. In such a case, the sound collecting apparatus 100 is called a “vibration information collecting apparatus”, and the microphone 110 is called a “sensor”. Details on this are as follows. The vibration information collecting apparatus is attached to a mobile body 90. The vibration information collecting apparatus includes a sensor that is directly or indirectly in contact with an outer face member 80, which is a member forming an outer face of the mobile body 90, from the inner side of the mobile body 90 and configured to collect information of vibration propagating through the outer face member 80.

Glass is appropriate as the outer face member 80, and, the sensor is disposed in a direction in which the information of vibration propagating from the outer face of the outer face member 80 to the inner side is collected in a case where the sensor has directivity, which are the same as in the First Embodiment.

The vibration information collecting apparatus according to the present disclosure includes the sensor that is in contact with the outer face member 80 from the inner side and thus can collect the information of vibration arriving at the outer face of the mobile body 90 using the sensor disposed inside the mobile body 90.

### The Second Embodiment

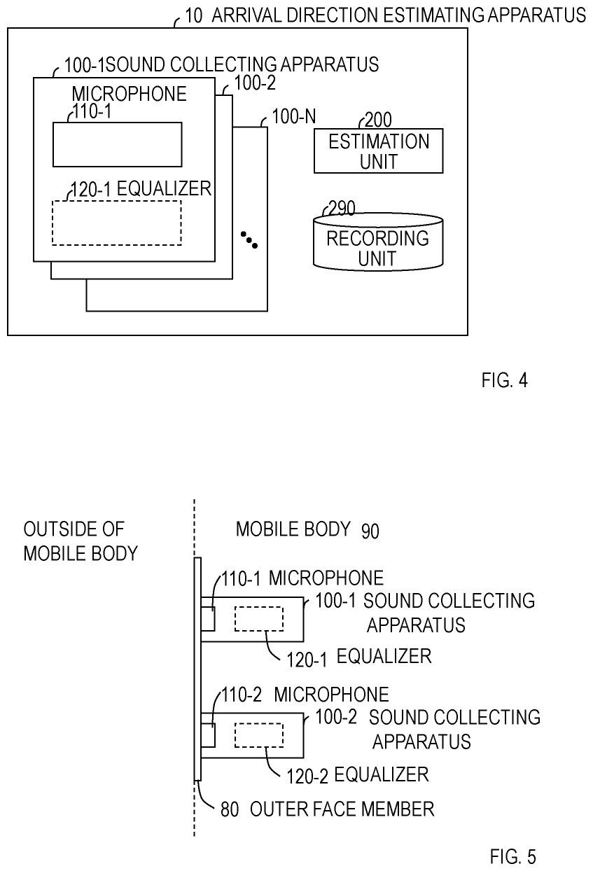

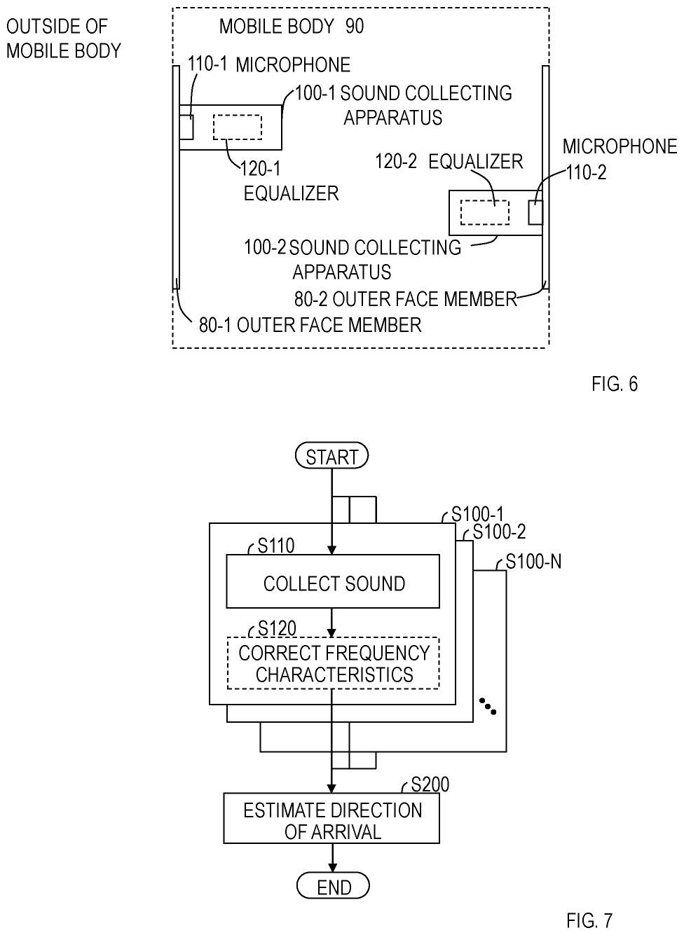

FIG. 4 illustrates an example of the functional configuration of a arrival direction estimating apparatus according to the Second Modification. FIG. 5 is a diagram illustrating a view in which a plurality of sound collecting apparatus are disposed in one outer face member, and FIG. 6 is a diagram illustrating a view in which sound collecting apparatuss are disposed in different outer face members. FIG. 7 is a diagram illustrating an example of a processing flow of the arrival direction estimating apparatus according to the Second Embodiment. The arrival direction estimating apparatus 10 includes N sound collecting apparatus 100-1, . . . , N, an estimation unit 200, and a recording unit 290. Here, N is an integer that is equal to or greater than 2, and n is an integer that is equal to or greater than 1 and equal to or smaller than N. Similar to the First Embodiment, the sound collecting apparatus 100-n collects sounds that propagate through the outer face member (S100-n). In addition, it is assumed that the outer face member is composed of a plurality of members. For example, in the case of a typical vehicle, the outer face member is composed of members such as a front glass, a rear glass, a vehicle body, doors, and the like.

There are the N sound collecting apparatus 100-1, . . . , N, and thus there are N microphones 110-1, . . . , N. The processing differs depending on how the microphones are disposed, and thus two cases will be described separately. A first case, as illustrated in FIG. 5, is a case where a plurality of sound collecting apparatus are disposed in one outer face member. In this drawing, the plurality of microphones 110-1 and 2 are in contact with the same member among members composing the outer face member 80. In this case, data relating to transmission characteristics of sounds that have actually been measured while changing the direction of arrival of the sounds is recorded in the recording unit 290 in advance. Then, the estimation unit 200 estimates the direction of arrival of the sounds from the outside of the mobile body 90 using the data recorded in the recording unit 290 (S200). As a method for the estimation, a multiple signal classification (MUSIC) method, a delay-and-sum method (DS method), a minimum variance method (MV method), or the like may be used. More specifically, a technology disclosed in Reference Literature 1 (JP 2014-090353 A) or the like is used. In the first case, there is an influence of the propagation characteristics of the outer face member 80. The influence of the propagation characteristics of the outer face member 80 is reflected in the propagation characteristics of the actually measured sounds described above, and thus the estimation unit 200 estimates the direction of arrival of sounds from the outside of the mobile body 90 with the propagation characteristics of the outer face member 80 taken into account.

A second case, as illustrated in FIG. 6, is a case where sound collecting apparatus are disposed in different outer face members. In this drawing, the microphones 110-1 and 2 are in contact with different members among members composing the outer face member. The microphone 110-1 is in contact with an outer face member 80-1, and the microphone 110-2 is in contact with an outer face member 80-2. Also in this case, data relating to the transmission characteristics of sounds that are actually measured while changing the direction of arrival of the sounds is recorded in the recording unit 290 in advance. Then, the estimation unit 200 estimates the direction of arrival of the sounds from the outside of the mobile body 90 using the data recorded in the recording unit 290 Similarly, as a method for the estimation, a MUSIC method, a delay-and-sum method (DS method), a minimum variance method (MV method), or the like may be used. In the second case, there is not only the influence of the propagation characteristics of the outer face members 80-1 and 2 but also the influence of diffraction characteristics in the mobile body 90, propagation characteristics of each member, and the like. In other words, there are influences of comprehensive transmission characteristics of the mobile body 90. The influence of the propagation characteristics of the mobile body 90 is reflected in the propagation characteristics of the actually measured sounds described above, and thus the estimation unit 200 estimates the direction of arrival of sounds from the outside of the mobile body 90 with the propagation characteristics of the mobile body 90 taken into account. For example, the outer face member 80-1 is a front glass of a vehicle, and the outer face member 80-2 is a rear glass of the vehicle.

When N is equal to or greater than 3, the first case and the second case may be combined. For example, N may be set to 6, three sound collecting apparatus 100-1, . . . , 3 may be disposed in one outer face member 80-1, and three sound collecting apparatus 100-4, . . . , 6 may be disposed in the other outer face member 80-2. A direction of arrival may be estimated by performing case classification of a case where only the sound collecting apparatus 100-1, . . . , 3 disposed in the outer face member 80-1 are used, a case where only the sound collecting apparatus 100-4, . . . , 6 disposed in the outer face member 80-2 are used, a case where the six sound collecting apparatus 100-1, . . . , 6 are used, and the like in accordance with a direction of arrival of sounds.

The arrival direction estimating apparatus according to the Second Embodiment includes the microphones that are in contact with the outer face members from the inner side, and thus sounds arriving at the outer face of the mobile body can be collected by the microphones disposed inside the mobile body. In addition, the arrival direction estimating apparatus according to the Second Embodiment can be disposed on the inside of a mobile body having a good environment, and thus can be less influenced by environmental factors such as weather and the like in a case where the direction of arrival of sounds is estimated.

The First Modification

The sound collecting apparatus 100-n may further include an equalizer 120-n. The equalizer 120-n receives an acoustic signal that is output from the microphone 110-n as an input. The equalizer 120-n corrects the input acoustic signal in accordance with frequency characteristics that are opposite to the frequency characteristics of the outer face member 80-n when sounds propagate from the outer face to the inner side. In this way, by including the equalizer 120-n, even when sounds of the outside are collected through the outer face member 80-n, a flat frequency characteristic can be achieved. The frequency characteristics of the outer face member 80-n when sounds propagate from the outer surface to the inner side is measured using the actual outer face member 80-n.

Program and Recording Medium

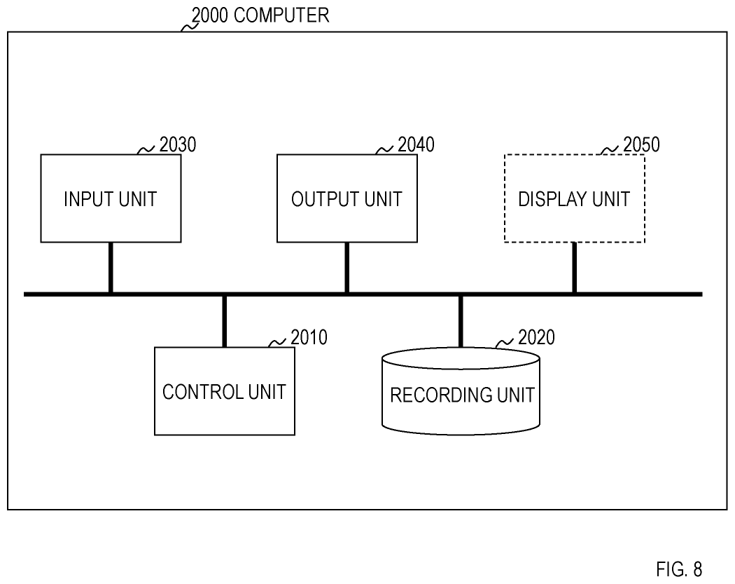

The processing operations of the equalizer 120 and the estimation unit 200 may be performed by causing the recording unit 2020 of the computer illustrated in FIG. 8 to read a program executing each of the steps of the above-described method and causing the control unit 2010, the input unit 2030, the output unit 2040, and the like to operate. In addition, the recording unit 2020 also serves as the recording unit 290.

The program in which the processing details are described can be recorded on a computer-readable recording medium. The computer-readable recording medium, for example, may be any type of medium such as a magnetic recording device, an optical disc, a magneto-optical recording medium, or a semiconductor memory.

The program is distributed, for example, by selling, giving, or lending a portable recording medium such as a DVD or a CD-ROM with the program recorded on it. Further, the program may be stored in a storage device of a server computer and transmitted from the server computer to another computer via a network, so that the program is distributed.

For example, a computer executing the program first temporarily stores the program recorded on the portable recording medium or the program transmitted from the server computer in the own storage device. When the computer executes the processing, the computer reads the program stored in the recording medium of the computer and executes processing according to the read program. As another execution mode of this program, a computer may directly read a program from a portable recording medium and execute processing according to the program. The computer may also sequentially execute processing in accordance with the program transmitted from the server computer each time the program is received from the server computer. In another configuration, the processing may be executed through a so-called application service provider (ASP) service in which functions of the processing are implemented just by issuing an instruction to execute the program and obtaining results without transmission of the program from the server computer to the computer. The program in this form is assumed to include information which is information provided for processing of a computer and is equivalent to a program (data or the like that has characteristics regulating processing of the computer rather than a direct instruction for a computer).

Also, in the present embodiment, the apparatus is configured by executing a predetermined program on a computer. However, at least a part of the processing contents may be implemented by hardware.

### REFERENCE SIGNS LIST

10 Arrival direction estimating apparatus
80 Outer face member
90 Mobile body
100 Sound collecting apparatus
110 Microphone
120 Equalizer
130 Sound insulation structure
200 Estimation unit
290 Recording unit

1. A sound collecting apparatus that is attached to a mobile body and is configured to collect a sound, the sound collecting apparatus comprising
a microphone that is directly or indirectly in contact with an outer face member, which is a member forming an outer face of the mobile body, from an inner side of the mobile body and is configured to collect a sound propagating through the outer face member.

2. The sound collecting apparatus according to claim 1, further comprising
a sound insulation structure configured to make the microphone difficult to collect a sound arriving from other than outside of the mobile body.

3. The sound collecting apparatus according to claim 1, wherein the microphone is disposed in a direction in which a sound propagating from an outer face of the outer face member to an inner side is collected.

4. The sound collecting apparatus according to claim 1, wherein the outer face member is glass.

5. The sound collecting apparatus according to claim 1, further comprising
an equalizer that has a frequency characteristic opposite to a frequency characteristic of the outer face member when a sound propagates from the outer face to the inner side, and is configured to receive an acoustic signal output from the microphone as an input.

6. A arrival direction estimating apparatus including a plurality of the sound collecting apparatus according to claim 1, wherein
the outer face member is composed of a plurality of members, and
a plurality of the microphones are in contact with an identical member among the plurality of members composing the outer face member, the arrival direction estimating apparatus comprising
an estimation unit configured to estimate a direction of arrival of a sound from outside of the mobile body with a propagation characteristic of the outer face member taken into account.

7. A arrival direction estimating apparatus including a plurality of the sound collecting apparatus according to claim 1, wherein
the outer face member is composed of a plurality of members, and
a plurality of the microphones are in contact with different members among the plurality of members composing the outer face member, the arrival direction estimating apparatus comprising
an estimation unit configured to estimate a direction of arrival of a sound from outside of the mobile body with a propagation characteristic of the mobile body taken into account.

8. A vibration information collecting apparatus that is attached to a mobile body and is configured to collect information of vibration, the vibration information collecting apparatus comprising
a sensor that is directly or indirectly in contact with an outer face member, which is a member forming an outer face of the mobile body, from an inner side of the mobile body and is configured to collect information of vibration propagating through the outer face member.

9. The arrival direction estimating apparatus according to claim 6, wherein
the sound collecting apparatus, further comprising
an equalizer that has a frequency characteristic opposite to a frequency characteristic of the outer face member when a sound propagates from the outer face to the inner side, and is configured to receive an acoustic signal output from the microphone as an input.

10. The arrival direction estimating apparatus according to claim 7, wherein
the sound collecting apparatus, further comprising
an equalizer that has a frequency characteristic opposite to a frequency characteristic of the outer face member when a sound propagates from the outer face to the inner side, and is configured to receive an acoustic signal output from the microphone as an input.
